(19) United States
(12) Patent Application Publication
(10) Pub. No.: US 2005/0269549 A1
(43) Pub. Date: Dec. 8, 2005

(54) Polyol premixes incorporating trans-1, 2-dichloroethylene

(76) Inventor: Jinhuang Wu, Norristown, PA (US)

Correspondence Address: ARKEMA INC.;PATENT DEPARTMENT - 26TH FLOOR, 2000 MARKET STREET, PHILADELPHIA, PA, 19103-3222, US

(21) Appl. No.: 10/859,305

(22) Filed: Jun. 2, 2004

(51) Int. Cl. C08J 9/18

(52) U.S. Cl. 252/182.24; 252/182.27

(57) ABSTRACT

A polyol premix which incorporates Tran-1,2-dichloroethylene is disclosed wherein the flash point of the premix is about 60° C. or above.

### FIELD OF THE INVENTION

The present invention relates to premixes for polyurethane based foam production. More particularly, the present invention relates to polyol premixes which incorporate Tran-1,2-dichloroethylene as an additive wherein the flash point of the premix is about 60° C. or above.

### BACKGROUND OF THE INVENTION

In the production of polyurethane based foams, various additives are included in foam or polyol premixes to enhance the processability or the properties of the premix or foam. Additives can include catalysts, surfactants, fire retardants, etc.

The use of Trans-1,2-dichloroethylene (Trans-1,2-DCE) as an additive to suppress smoke generation of the blown foam is disclosed in U.S. patent application Ser. No. 10/774,973.

The use of Trans-1,2-DCE to improve processability of hydrofluorocarbon (HFC) and/or pentane-based blowing agent containing premixes is disclosed in U.S. patent application Ser. No. 10/420,472.

Handling of Trans-1,2-DCE is problematic because of its relatively low flash point of −12° C. Flash point as used herein relates to flash point as measured using a Setaflash “series 7” flash point tester. Current United States Department of Transportation regulations designate liquids having a flash point less than 60° C. as flammable for transportation purposes. Thus, transportation of Trans-1,2-DCE for use in foam production is problematic.

Prior methods to provide “non-flammable” Trans-1,2-DCE have focused on mixing it with a non-flammable compound having a volatility similar to Trans-1,2-DCE to suppress (raise) the flash point. For example Novec™ engineered fluid HFE-71DE available from Minnesota Mining and Manufacturing Co. comprises a blend of Trans-1,2-DCE and methylnonafluorobutylether (C₄F₉OCH₃). This blend is non-flammable and has no flash point. Such methods resulted in adding an additional volatile compound or compounds to Trans-1,2-DCE which compounds can become incorporated into the foam produced with the mixture. In addition, the use of such volatile compounds adds to the global warming potential (GWP) of the mixture. These results are undesirable.

### BRIEF SUMMARY OF THE INVENTION

A method of suppressing or elevating the flash pint of Trans-1,2-DCE additive for use in polyurethane foam production is provided. The method comprises adding Trans-1,2-DCE to polyol premixes in an amount effective to provide a premix flash point of about 60° C. or higher. Preferred polyols are polyester polyols, polyether polyols or mixtures thereof. Because the polyols are raw materials and Trans-1,2-DCE is a desirable additive in the production of foams, no “additional” materials are added to the final product and the GWP of the premix is not increased.

### DETAILED DESCRIPTION

It has been discovered that the flash point of Trans-1,2-DCE can be suppressed or elevated to about 60° C. or above by mixing Trans-1,2-DCE with polyols. The ratio of Trans-1,2-DCE to polyol effective to achieve the desired flash point of 60° C. or above is dependant on the properties of the specific polyol. For a polyester polyol having a hydroxyl number of 230-250 and a flash point higher than 93.9° C., the preferred ratio of polyester polyol to Trans-1,2-DCE is at least 96.9 wt % polyester polyol to 3.1 wt % Trans-1,2-DCE. For a polyether polyol having a flash point higher than 185° C., the ratio of polyether polyol to Trans-1,2-DCE is at least 95 wt % polyether polyol to 5 wt % Trans-1,2-DCE.

Polyols such as polyester polyols and polyether polyols are raw materials in the production of polyurethane foams via conventional techniques. Trans-1,2-DCE is an additive used in polyurethane foam production that provides processability enhancements, smoke generation suppression etc. The mixture of two polyurethane foam raw materials, Trans-1,2-DCE and a polyol, provides a means of transporting and handling Trans-1,2-DCE in a “non-hazardous” combination. The mixture is useful in the production of premixes for polyurethane foams alone or when combined with other premix additives such as catalysts, fire retardants, surfactants, blowing agents such as hydrofluorocarbon or pentane and water.

The present invention provides a means for transporting and handling Trans-1,2-DCE in a “non-hazardous” condition for use in polyurethane foam production.

The present invention is illustrated in more detail in the following non-limiting examples.

### EXAMPLE 1

The flash point measurement of Trans-1,2-DCE was conducted using Setaflash “series 7” flash point tester available from Petroleum Systems Services Corporation. The test was conducted according to ASTM D3828-02 “Standard Test Method for Flash Point by Small Scale Closed Cup Tester”. The equilibrium mode was used is obtain the flash point. The measured flash point of Trans-1,2-DCE was −12° C.

### EXAMPLE 2

The flash point measurement of Trans-1,2-DCE/polyol blends was conducted using Setaflash “series 7” flash point tester available from Petroleum Systems Services Corporation. The test was conducted according to ASTM D3828-02 “Standard Test Method for Flash Point by Small Scale Closed Cup Tester” with modification of sample loading method when the expected flash point was below room temperature. Because the mixtures of Trans-1,2-DCE and polyols are very viscous at low temperature, they were kept at room temperature and loaded into the cup. Also, a longer equilibrium time, 2-5 minutes instead of 1 minute was used when measuring flash point of Trans-1,2-DCE/polyol blends.

The results are summarized in Tables 1 and 2:

TABLE 1
Flash Point of Trans-1,2-DCE/PS2352 blends

| wt % Polyol 2352 | wt % Trans | T_{flash} (° C.) |
|---|---|---|
| 96.9 | 3.1 | >60 |
| 95.7 | 4.3 | 58 |
| 95 | 5 | 57 |
| 93.3 | 6.7 | 43 |
| 89.8 | 10.2 | 32 |
| 89.1 | 10.9 | <35 |
| 0 | 100 | −12 |

STEPANOL ® PS2352 is a polyester polyol available from Stepan Co.

TABLE 2
Flash Point of Trans-1,2-DCE/Voranol 220 blends

| wt % Voranol 220 | wt % Trans | T_{flash} (° C.) |
|---|---|---|
| 95 | 5 | >60 |
| 94 | 6 | 54 |
| 92 | 8 | 46 |
| 89.7 | 10.3 | 35 |
| 0 | 100 | −12 |

Voranol ® 220 is a polyether polyol available from Dow Chemical Co.

The results show that a combination of a polyol and Trans-1,2-DCE can exhibit a flash point of 60° C. or above.

While the present invention has been described with respect to particular embodiment thereof, it is apparent that numerous other forms and modifications of this invention will be obvious to those skilled in the art. The appended claims and this invention generally should be construed to cover all such obvious forms and modification which are within the true spirit and scope of the present invention.

1-3. (canceled)

4. A premix for the production of polyurethane foam consisting of a mixture of (a) a polyether polyol and (b) Trans-1,2-dichloroethylene, wherein said Trans-1,2-dichloroethylene is present in an amount less than about 5 weight % effective to result in a flash point of said mixture of about 60° C. or above.

5. (canceled)

6. (canceled)
